(19) United States
(12) Patent Application Publication
(10) Pub. No.: US 2017/0124810 A1
(43) Pub. Date: May 4, 2017

(54) METHOD AND SYSTEM FOR POKER GAMING

(71) Applicants: Andrew John Fraser, Los Angeles, CA (US); Rand Gregory Holdren, Studio City, CA (US)

(72) Inventors: Andrew John Fraser, Los Angeles, CA (US); Rand Gregory Holdren, Studio City, CA (US)

(21) Appl. No.: 15/341,627

(22) Filed: Nov. 2, 2016

Related U.S. Application Data
(60) Provisional application No. 62/250,321, filed on Nov. 3, 2015.

(51) Int. Cl. G07F 17/32

(52) U.S. Cl. CPC G07F 17/3293; G07F 17/322

(57) ABSTRACT

A novel method and system of game play and game components referred to herein as HULA or HULA Poker that in one embodiment includes playing cards. In the present invention, a Texas Hold 'Em community card poker game incorporates the addition of a separate deck referred to herein as HULA Cards and a series of HULA Action Elements and HULA Action Commands that are initiated through audience participation and viewer activation. The HULA Elements and HULA Commands are a series of Player executed wildcards, rules and actions designed to alter the course of the game. The game components may take many forms and be played in various competitive environments, such as a home game, a tournament style casino game, and/or a game with audience participation. The game of the present invention may further be played in different media such as, but not limited to, electronic games, video games, computer games, online games, online gambling, casino play, interactive networks, and computer applications.

### RELATED APPLICATION

This application claims the benefit of U.S. Provisional Patent Application No. 62/250,321 filed Nov. 3, 2015 entitled METHOD AND SYSTEM FOR POKER GAMING which is hereby incorporated herein by reference in its entirety.

### FIELD OF THE INVENTION

The present invention is a novel method and system of game play and game components referred to herein as HULA or HULA Poker that in one embodiment includes playing cards. In the present invention, a Texas Hold 'Em community card poker game incorporates the addition of a separate deck referred to herein as HULA Cards and a series of HULA Action Elements and HULA Action Commands that are initiated through audience participation and viewer activation. The HULA Elements and HULA Commands are a series of Player executed wildcards, rules and actions designed to alter the course of the game. The game components may take many forms and be played in various competitive environments, such as a home game, a tournament style casino game, and/or a game with audience participation. The game of the present invention may further be played in different media such as, but not limited to, electronic games, video games, computer games, online games, online gambling, casino play, interactive networks, and computer applications.

### BACKGROUND OF THE INVENTION

The underlying rules and game play are traditional Texas Hold 'Em, as outlined in “Hoyle's Rules of Games” (Morehead, Albert H, and Jeffrey Mott-Smith. Hoyle's Rules of Games; New York: Penguin Group, 2001, 241-261, Print.), which is incorporated by reference herein. Texas Hold 'Em is a variant of a standard poker game in which Players buy chips to bet with and two cards referred to as Hole cards are dealt face down to each Player. The Dealer then deals three cards face up, a fourth card is dealt, and fifth card is dealt with a series of betting between each deal where the Players may check, bet raise or fold. Players may be eliminated from the game when they run out of chips to bet with and the remaining Player in the game having chips may be declared the winner. Following is a description of the setup and rules of Texas Hold 'Em, however Hoyle Rules of the game of Texas Hold 'Em supersede these rules in the event there are any inconsistencies.

### Choosing a Dealer

To choose the Dealer, either a card is dealt to every Player, or the cards are spread out face down on the table and each Player chooses one. The Player with the highest-valued card (aces are high for selecting a Dealer) starts as the Dealer. A Dealer button or other indicator may be placed in front of the Player chosen as the Dealer with the task of dealing and Dealer button being transferred to the Player to the left of the Dealer at the end of the hand.

### Putting Out the Blinds

After a Dealer is chosen, the two Players to the left of the Dealer need to put out the blinds which is a forced bet by each of the Players similar to an ante. There are two blinds in Texas Hold 'Em—a small blind and a big blind. The Player directly to the left of the Dealer puts out the small blind. The big blind which is exactly, or conveniently close to, double that of the small blind is placed by the Player to the left of the small blind.

### Game-Play and Betting Rounds

The Player dealing the cards deals to the left of the Player with the Dealer button first, rotating around the table in a clockwise manner, giving each Player one card at a time until each Player has two cards. These are known as a Player's Hole cards. A hand of Texas Hold 'Em consists of a minimum of one and a maximum of four betting rounds. A hand ends when all Players but one have folded, or the fourth and final betting round completes with multiple Players still in the hand—whichever comes first. At that point, Players enter into the Showdown as described herein.

### Pre-Flop

When all Players receive their Hole cards, the Pre-Flop betting round begins. Each Player must look at their cards and decide what action they would like to take. In Texas Hold 'Em, only one Player can act at a time. The Pre-Flop betting round starts with the Player to the left of the big blind. This Player has four options:

Fold: They pay nothing to the pot and throw away their hand, waiting for the next deal to play again.

Call: They match the amount of the big blind.

Raise: They raise the bet by doubling the amount of the big blind. A Player may raise more if they choose.

Once a Player has made their action, the Player to the left of them gets their turn to act. Each Player is given the same options: fold, call the bet of the Player to their right (if the previous Player raised, then the next Player to bet must bet an amount equal to the amount raised to call) or raise.

### The Flop

Once the Pre-Flop betting round ends, the Flop is dealt. This is done by dealing the top card in the deck face down on the table (it becomes the burn card), followed by three cards face up. Once this has been dealt, the first post-Flop betting round begins. The rules of a post-Flop betting round are the same as a Pre-Flop, with two small exceptions: The first Player to act is the next Player with a hand to the left of the Dealer, and that Player may check or bet; as there has been no bet made, checking is free. A bet on the Flop is a minimum of the amount of the big blind.

### The Turn

Once the betting round on the Flop completes, the Dealer deals one card facedown (burn card) followed by a single card face up, also known as the “burn and turn.” Once the Turn also referred to as Fourth Street has been dealt, the third betting round starts. The third betting round is identical to the Flop betting round.

### The River

Assuming more than one Player is left, having not folded on one of the previous rounds or streets, the River is now dealt. Dealing the River is identical as dealing the Turn, with one card being dealt facedown, followed by a single card face up. This is the final round also referred to as Fifth Street and no more cards will be dealt in this hand. The betting round is identical to the betting round on the Turn.

### The Reveal

Once the River betting round has been completed, the Players now reveal their hands to determine the best hand and that Player wins the pot. The rules for revealing the hands in Texas Hold 'Em are as follows: The Player who bet on the River is the default first Player to reveal their hand. If any other Players choose to show their hand first, that is OK. If no betting happened on the River (all Players checked), the Player closest to the left of the Dealer must open their hand first, continuing clockwise around the table. If a Player is holding a losing hand, it is their option to reveal their cards or simply muck their hand and concede the pot.

### Elimination

If a Player bets all of their chips on a hand and loses, that Player is eliminated from the game. Depending on the rules of play, the Player may have an option to Re Buy and reenter the game by buying more chips or remain out of the game. As each hand is played and Players are eliminated, the remaining Players continue until only two Players have chips and remain in the game.

### Showdown

When all other Players have been eliminated and only two Players remain in the game, the Showdown begins with the same rounds of betting, the Pre-Flop, the Flop, the Turn and the River within each hand. A winner is declared when one Player wins all of the others Player's chips.

Similar to other card games, Texas Hold 'Em has unique terminology to describe the components of play. A brief glossary of some of these terms that may be encountered during game play is as follows:

Blinds: Short for “blind bets” these are the forced bets made before the cards are dealt. In Texas Hold 'Em, blinds take the place of the classic “ante.”

Board Cards: Name for the Flop, Turn or River community cards dealt before each round of betting.

Button: Nickname or indicator for the Player acting as the Dealer in current hand. It rotates clockwise each hand once game is started.

Check: Similar to a call but no money is bet. If there is no raise during the Pre-Flop, the big blind may check.

Circus Deal: Dealing the cards in a non-traditional manner where routine order does not apply. Cards may be dealt in any fashion so long as every Player gets two.

Community Cards: Cards dealt face up by the Dealer and used by all Players to complete their hands.

Dead Soldiers: Folded cards in front of a Player.

Fifth Street: The final (5th) community card dealt; also known as the River

Flop: The first three community cards dealt.

Fourth Street: The fourth (4th) community card dealt; also known as The Turn.

Muck: To discard a card or hand of cards from active play by folding them, and removing them from a state of being active, to be inert and not involved in play going forward.

Pre-Flop: Anything that occurs before the Flop is dealt is Pre-Flop.

River: The round of betting following the dealing of the final (5th) community card.

Showdown: When Players reveal their hands to discover the pot's winner.

Turn: The round of betting following the dealing of the fourth (4th) community card.

As described the standard play of Texas Hold 'Em like many other styles of poker games involves actions only by the Players within the game and is a repetitive series of deals and betting until the River, the final round of betting, when the cards are revealed. The present invention referred to herein as HULA Poker is an antidote to these stale and tired formats of traditional poker games, and provides an exciting and entertaining alternative to the traditional format of Texas Hold 'Em Poker.

### SUMMARY OF THE INVENTION

The present invention is a unique variation of the Texas Hold 'Em community card poker game that incorporates the addition of a separate deck referred to herein as HULA Cards. The HULA Cards are a series of Player executed wildcards, rules, and action elements designed to alter the course of the game.

It is an advantage of the present invention that when this deck of playing cards entitled HULA Cards is introduced into the traditional realm of play, that the Players will enjoy the experience more and the amount of play will increase.

It is a further feature of the present invention that each participant has a marker or indicator game component present at the table to clarify their status of being “IN” or “OUT.” In one embodiment, the indicator is in the form of a small cup before each Player. If the cup is standing upright, this indicates that the Player is still an active participant in the round of play currently underway. If it is tipped upside down, then that Player has ‘folded’ and is no longer “IN” or a part of play for that hand.

It is an object of the present invention to introduce an entirely new dimension of strategy to the game of Texas Hold 'Em Poker, by causing the Players at the table to incorporate into their respective playing strategies the possibility of various HULA Poker cards being played, thus injecting greater uncertainty and greater jeopardy into the proceedings, augmenting the enjoyment of both the game-playing and game-viewing experience.

It is an advantage of the present invention that the introduction of the ‘wild factor’ of the HULA deck cards to the traditional game does a great deal to level the playing field among Players by removing certain advantages that long time Players will have over newer Players due to the series of automatic card calculations that many professionals and experienced Players deliberately or unconsciously undertake in deciding how to play their hands.

It is an advantage of the present invention that despite the plurality of novel cards in the HULA deck and multitude of audience participation opportunities integrated into the stream of play, the rules are fundamentally quite simple and easy to understand so as to appeal to as broad an audience as possible.

It is a further advantage of the present invention that the multitude of audience participation opportunities will further engage the viewing audience to a greater degree than had been afforded prior to this invention. They will be able to effect change upon the play itself, elevating their status from casual observer to active participant, and in doing so, give them a more fundamentally entertaining experience.

The method of the present invention generally involves a typical casino or cardroom version of Texas Hold 'Em Poker that has been modified to incorporate a second deck of playing cards, known as the HULA Cards, comprised of playing cards designed to change the stakes of the game by actively changing the cards or the value of the cards Players have in their hands, as well as cards that appear over the course of play.

During the normal course of playing a round of the traditional Texas Hold 'Em game, a Player making a wager would have to base their judgment and course of action on the cards they have vs. the cards their opponent has. With the addition of the HULA Cards, they must now also take their own HULA Cards into account, as well as their assessment of the HULA Cards that their opponents may or may not have. This presents a new avenue of strategic decision-making to be mastered, and changes the old game into something new and fundamentally different because of all of the additional rules and action elements and the possibilities of how these action elements impact the game.

The HULA Cards are but one agent of change present in this new invention—active audience participation is another. Unlike traditional Texas Hold 'Em Poker where the audience may not impact the play at the table, HULA Poker encourages the audience to effect different outcomes at the table by affording them a number of opportunities to change the stakes of the Players, the hands of the Players, and the amounts of the wagers at stake under different and ever-shifting sets of circumstances and manners.

In traditional Texas Hold 'Em Poker, when a Player decides not to pursue their hand any further and decides to muck or fold their cards, thus getting out of the action, and waiting for the next deal to begin, they place the cards face down and hand them over to the Dealer (or ‘push them into the middle’), where they are removed from play. In HULA Poker, because of the addition of the HULA Cards, there are a number of scenarios in which a Player may return from a folded position, or another Player may access the cards that the folded Player has set aside.

Because of this, it is important that there be a method for binding a Player to their cards, even in the event of having folded. In the preferred embodiment, this method is known as the Red Cup and Coaster system. The Red Cup can be either an actual small, ceramic or other material cup, or a token, marker, or game piece or an electronic or mechanical signaling apparatus or system that serves the same function. In the preferred embodiment, the Coaster is an electronic sensor at the playing table connected to a main control board that is under the sole operational control of the Dealer.

The Red Cup and Coaster system serves two functions. The first function is to display a Player's status to the table. In the preferred embodiment, if the Red Cup is standing in an upright position near the Coaster indicator, then that Player is active. If the Player folds then the folded cards are placed on the Coaster and the Red Cup is placed in an upside down position on top of the folded cards instead, this marks that Player as “Out”, but also preserves the connection of that Player to his folded hand. In another embodiment, if the folded cards are inserted into a sleeve or other container before the Player, this marks that Player as “Out”, but also preserves the connection of that Player to his folded hand. The Coaster may have an electric signal such as a LED light or other indicator that shows the Player has folded. The electric signal from the Coaster may also be transmitted to a control board for display or to indicate to the Dealer how many Players have folded on a counter showing the total number of Players. The Counter may further keep track of each time a Player folds.

The apparatus of Audience Participation may differ from platform to platform, in that the manner of participating in an Online Streaming Tournament may be different from that of a Live Event, which in turn is different from the Home Game. To that end, the various embodiments include, but are not solely limited to, apparatus and systems to enable audience members to affect their vote or participation in the game play. Various known communication apparatus and systems may be utilized, including handheld communication devices, mechanical and electro-mechanical devices, and software applications which would allow audience members to participate.

The present invention is related to a poker game as a variation of Texas Hold 'Em poker that comprises a deck of standard playing cards configured to and following the rules of play to play a game of Texas Hold 'Em poker; and a plurality of action elements having player executed rules and actions designed to alter the course of play of the Texas Hold 'Em poker game. In embodiments of the poker game, the plurality of action elements may be in the form of a deck of cards. In embodiments of the poker game, the plurality of action elements may be selected from a group consisting of: an action element requiring the dealing of a third hole card; an action element requiring the retrieving of a players last bet from the pot; an action element requiring the voiding of an action element executed by another player; and an action element requiring the capping of the bets to a set amount within a round. In embodiments of the poker game, the plurality of action elements may further be selected from a group consisting of: an action element requiring the showing of a flop, turn or river card to a player executing the action element before the card is shown to the other players; an action element requiring the discarding of at least one hole card and the random selection of at least one new hole card from the standard playing deck; an action element requiring the asking and taking of a specific card from a player forcing the player to select another hole card from the deck of standard playing cards or if the player does not have the card selecting another hole card from the deck of standard playing cards; and an action element requiring the retrieving of at least one of the cards from a player that has folded. In embodiments of the poker game, the plurality of action elements may further be selected from a group consisting of: one of the plurality of action elements selected from a group consisting of: an action element requiring the displaying of all jacks held by all players and the choosing of a jack from those displayed by a player executing the action element; an action element requiring the displaying of all queens held by all players and the choosing of a queen from those displayed by a player executing the action element; and an action element requiring the displaying of all kings held by all players and the choosing of a king from those displayed by a player executing the action element. In embodiments of the poker game, the plurality of action elements may further be selected from a group consisting of: an action element requiring the discarding and re-dealing of a flop card; an action element requiring the discarding and re-dealing of a turn card; and an action element requiring the discarding and re-dealing of a river card. In embodiments of the poker game, the plurality of action elements may further be selected from a group consisting of: an action element requiring the adding or subtracting of a digit to one of the hole cards of a player executing the action; an action element requiring the changing of the suit of one of the hole cards of a player executing the action element; an action element requiring the receiving of an additional hole card for a player executing the action element; an action element requiring the exchanging of two hole cards with a next active player that is sitting two seats away from a player executing the action element; and an action element requiring the displaying of a hole card to all other players by a player executing the action element. In embodiments of the poker game, the plurality of action elements may further be selected from a group consisting of: an action element requiring the receiving of an additional hole card from the deck of standard playing cards by all players and the discarding of a hole card by all players; and an action element requiring the passing of one hole card by all players to a player behind them in the deal. In embodiments of the poker game, the plurality of action elements may further be selected from a group consisting of: an action element requiring allowing a player that had folded during the game to re-enter the game by executing an action element; an action element requiring forcing a player other than a player that has executed the action element to remain in the game and bet each round; and an action element requiring allowing a player that has executed the action element to not bet during the rounds but still remain in the hand.

Embodiments of the poker game may comprise a plurality of action commands activated through viewer participation where the viewer participation is through one of at least popular vote or head count. Embodiments of the poker game may comprise a plurality of action commands activated through random selection and may comprise a wheel configured to activate one of the plurality of action commands through random selection. In embodiments of the poker game, the plurality of action commands may be selected from a group consisting of: an action command requiring an alarm that freezes the deal and requires all players to bet with the cards that they currently have; an action command requiring a player that has not bet, must bet every bet and cannot fold; an action command requiring that players have the option to bet, check, or fold on the flop burn card, the flop card, and the turn burn card; an action command requiring all players must bet every bet and cannot fold; and an action command requiring the winner of the hand to return half of their winnings to the pot. In embodiments of the poker game, the plurality of action commands may further be selected from a group consisting of: an action command requiring viewers of the game to play a hand for a player; an action command requiring the next card from the deck of standard playing cards dealt after a queen be wild; an action command requiring all players to play with one hole card face up; and an action command requiring a card dealt prior to a burn card is wild. In embodiments of the poker game, the plurality of action commands may further be selected from a group consisting of: an action command requiring a flop card being dealt face down; an action command requiring a turn card being dealt face down; an action command requiring a river card being dealt face down; and an action command requiring all players placing their set of keys into a bowl and selecting a set of keys that is not their own set of keys and exchanging their hole cards with the owner of the set of keys they selected.

In embodiments of the poker game, the plurality of action elements may comprise a plurality of activation codes indicating when one of the plurality of action elements may be used during play, the plurality of activation codes may be selected from a group consisting of: an activation code indicating the action element may be used at any time; an activation code indicating the action element may be used only when at least three players are active in a round of the variation of the Texas Hold 'Em poker game; an activation code indicating the action element may be used only during the flop round; an activation code indicating the action element may be used only during the turn round; and an activation code indicating the action element may be used only during the river round.

Embodiments of the poker game may comprise a marker configured to have an active state to indicate a player is participating in a round of the variation of the Texas Hold 'Em poker game; and a non-active state to indicate a player is not participating in a round of the variation of the Texas Hold 'Em poker game. Embodiments of the poker game may comprise a controller; a plurality of sensors configured to determine the state of the marker as active or non-active and send a single to the controller to indicate a player is participating in a round of the variation of the Texas Hold 'Em poker game; and a counter configured to determine the number of rounds a player participates in. In embodiments of the poker game, the marker may comprise a red cup, a sensor may comprise a coaster and if a player is active, the red cup is placed in an upright position; and if the player is non-active, the player's cards are placed on the coaster and the red cup is placed in an upside-down position in order to associate the non-active player's cards with the player thereby providing the opportunity for the player to become active and reenter the game.

The present invention is further related to a method of playing hula poker as a variation of a Texas Hold 'Em poker game, comprising dealing two hula cards to each player, each hula card having one of a plurality of action elements; dealing two hole cards from a standard deck of cards to each player; having each player chips to be used for betting; having each player choose to participate in any round of the game by placing a marker in an active position or choose to not participate in any round of the game by placing the marker in a non-active position; having any player choose to play a hula card prior to the pre-flop round and if played performing the instructions indicated by the action element; having each player whose turn it is choose to play a hula card and having the instructions indicated by the action element performed prior to the player choosing to fold, call or raise during the pre-flop round; dealing the flop cards; having each player whose turn it is choose to play a hula card and having the instructions indicated by the action element performed prior to the player choosing to fold, call or raise during the post-flop round; removing any un-played hula cards from the players and dealing two new hula cards; dealing the turn card; having each player whose turn it is choose to play a hula card and having the instructions indicated by the action element performed prior to the player choosing to fold, call or raise during the turn round; dealing the river card; having each player whose turn it is choose to play a hula card and having the instructions indicated by the action element performed prior to the player choosing to fold, call or raise during the river round; revealing the hand of each player and giving the player with the best hand the pot; eliminating players that have no more chips for betting until only two players remain for the showdown rounds; removing hula cards from the hula deck that cannot be played when there are only two players; removing any un-played hula cards from the players and dealing two new hula cards; playing pre-flop, post-flop, turn and river rounds with the option to play a hula card during anyone of these rounds until only one player has chips for betting; declaring a winner as the only player having chips.

These and other features, advantages and improvements according to this invention will be better understood by reference to the following detailed description and accompanying drawings.

### BRIEF DESCRIPTION OF THE DRAWINGS

The invention, together with further objects, features, aspects and advantages thereof will be more fully understood and appreciated by consideration of the following description in conjunction with the accompanying drawings in which the respective elements bear the same reference numerals throughout the various views.

FIG. 1A is a diagrammatic representation of an embodiment of a layout of the HULA Poker card game of the present invention using a casino gaming table and showing the Red Cup and Coaster system that tethers a Player to the cards of their hand in the event of their folding;

FIG. 1B is a diagrammatic representation of an embodiment of a layout of the HULA Poker card game of the present invention using a casino gaming table and showing the Red Cup and Coaster system in an active state to tether a Player to the cards of their hand after folding;

FIG. 2A is a diagrammatic representation of an embodiment of the back of a HULA Card with various indicia such as lettering or a decorative design to indicate the HULA Card is different from the playing cards;

FIG. 2B is a diagrammatic representation of an embodiment of the face of a HULA Card displaying the title, name of the rule, the description of the Action Element that includes instructions that alter game play and an Activation Code which indicates when the card may and may not be played;

FIG. 3A is a diagrammatic representation of an embodiment of the back of a HULA Card with various indicia such as a decorative design to indicate the HULA Card is different from the playing cards;

FIG. 3B is a diagrammatic representation of the face of a HULA Card according to the preferred embodiment, with the various indicia of a title of the Action Element and the instructions that dictate how the Player may affect play with the card, as well as an Activation Code which indicates when the card may and may not be played;

FIG. 4 is a diagrammatic representation of a viewing screen for audience participation displaying a HULA Poker event and options for a viewer to select a HULA Command to affect game play;

FIG. 5 is a diagrammatic representation of an embodiment of a HULA Wheel;

FIG. 6 is a diagrammatic representation of an embodiment of a layout of the HULA Poker card game of the present invention using a casino gaming table and showing the Red Cup and Coaster system that tethers a Player to the cards of their hand in the event of their folding, and an embodiment of a HULA Wheel used during game play;

FIG. 7A is a cross-section of an embodiment of a HULA Wheel;

FIG. 7B is side elevation view of an embodiment of a HULA Wheel; and

FIG. 8 is a diagrammatic representation of an embodiment of a layout of the HULA Poker card game of the present invention using a casino gaming table and showing the Red Cup and Coaster system that tethers a Player to the cards of their hand in the event of their folding, and a further embodiment of a HULA Wheel used during game play.

### DETAILED DESCRIPTION OF THE PREFERRED EMBODIMENTS

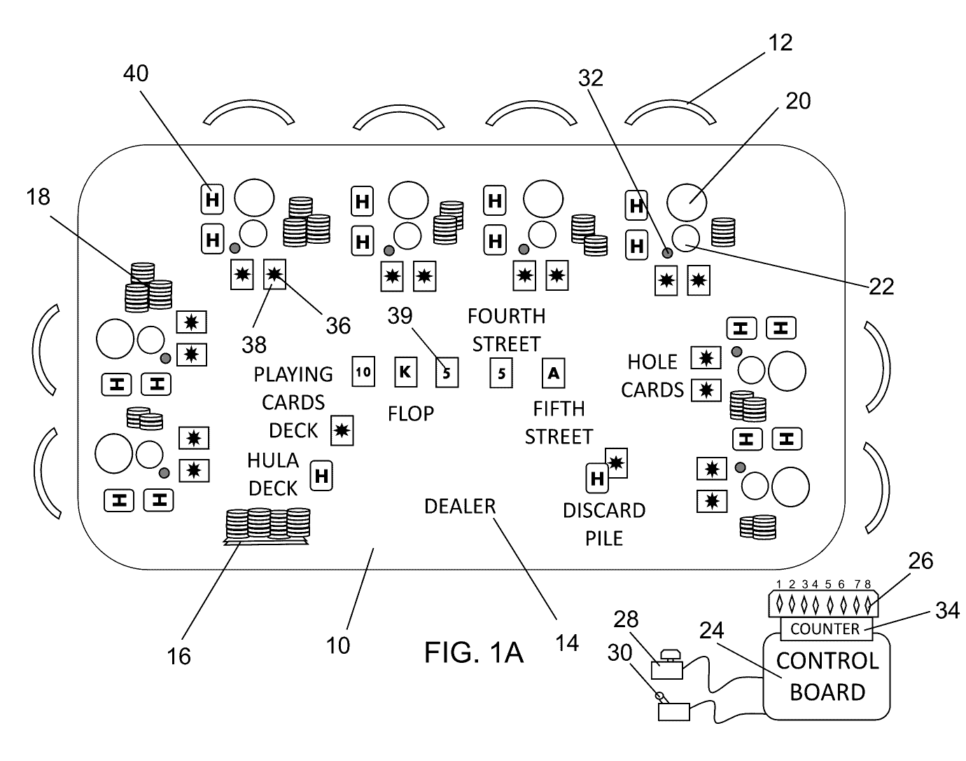

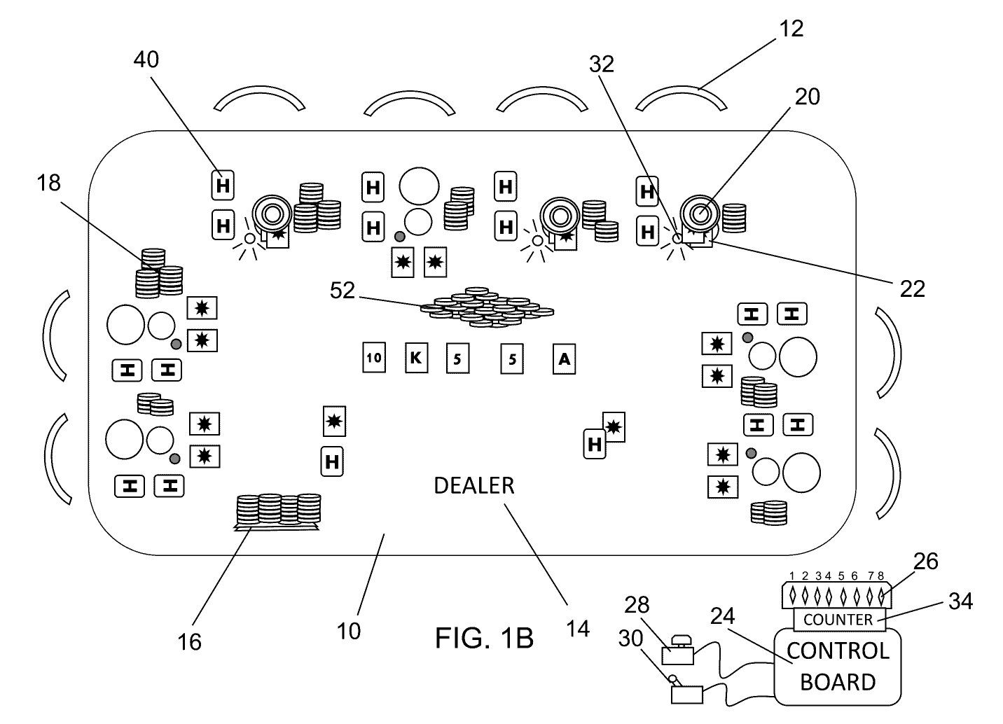

In an embodiment of the present invention as shown in FIG. 1, a casino gaming table 10 is provided having a plurality of playing locations 12 for Players participating in the game being conducted, e.g., Texas Hold 'Em Poker. A Dealer is positioned at the Dealers' location 14. The Dealer location 14 may preferably be located adjacent a chip rack 16 and each Player has chips 18 representing their stake in the game and winnings. Adjacent to each playing location 12 is a Red Cup 20, and a Coaster sensor 22, the latter of which is connected, directly or wirelessly, to a main control board 24, with lights or other visible indicators 26 corresponding to the number of playing locations 12 provided on the gaming table 10. In some embodiments, the Red Cup 20 and Coaster sensor 22 is just an indicator and not electrically connected to a control board. As shown in FIG. 1, eight playing positions are preferably provided, although the number of playing locations 12 can be more or less than eight. A reset switch 28 may be located adjacent to the Dealer's location 14 and is connected, directly or wirelessly, to the main control board 24 and provides a means whereby the Dealer can reset the Coaster sensors 22 prior to the beginning of each play of each hand, or as circumstances change during the course of play. A lockout switch 30 may also be placed adjacent to the Dealer's location 14 which is activated by the Dealer to prevent an unsupervised change in status of a Player, as will be more fully explained herein.

In this embodiment, the present invention operates with each Player being dealt two (2) HULA Cards 40 by the Dealer, at the beginning of the game. HULA Cards 40 may be dealt in any manner, such as the traditional sequential deal to players from left to right, or in a Circus Deal (where the cards are randomly dealt). In the preferred embodiment, the Dealer distributes HULA Cards 40 from the top of the deck, in order of appearance, without “burning” any HULA Cards 40 in the process. The contents of the HULA Cards 40 are known only to the Player receiving them to be used at the recipient's discretion, during their subsequent turns.

Following the distribution of the allotted HULA Cards 40, a traditional game of Texas Hold 'Em Poker as described above commences at the gaming table 10. At the beginning of each hand, each Player makes their respective wager, and either stands the Red Cup 20 in an upright position on the Coaster 22 to indicate that they are eligible to participate in the wagering, or they fold and place their folded cards on top of the Coaster 22 and then place the Red Cup 20 upside down on top of their folded cards as shown in FIG. 1B, to indicate that they are ‘out’ and not engaged in active play. As will be more fully explained herein, the Coaster 22 ‘recognizes’ that a Red Cup 20 has been placed on top of it, and an indicator signal 32, preferably a light adjacent to the Coaster 22 is activated, showing that a particular Player is participating in the active play of this hand.

Besides activating the indicator signal light 32 the Coaster 22 also sends a signal to the main control board 24. This signal is sent by the main control board 24 to the counter 34 corresponding to the particular playing location 12 to keep a sequential count of the number of times that a given Player has decided to participate in the wagering.

Once a Player has decided whether or not the Player is going to participate in this round of betting and has placed the Red Cup 20 in an Active or Folded position, the Dealer activates the lockout switch 30 to lock in the current position of each Coaster 22, preventing Players from changing their status of being In or Out at the table 10. Only the Dealer, by deactivating the lockout switch 30 may allow a Player back into active play.

When a Player wins the pot 52 of a particular hand, then the Dealer manually resets the lockout switch 30 to deactivate the various indicator signals 26 and reset the signal lights 32 of the Coaster 22 to non-illuminated, allowing the process to begin anew.

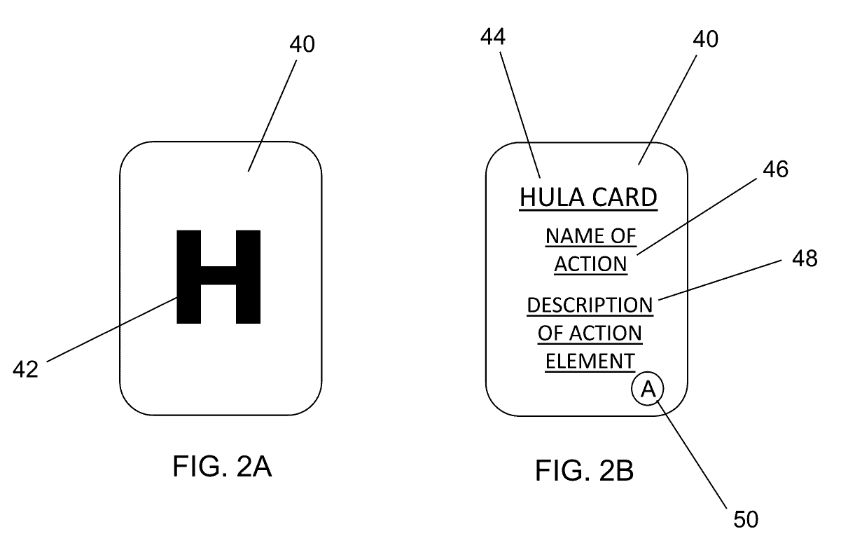

The back of the HULA Card 40, as shown in FIG. 2A, may have indicia 42 such as a letter, picture or drawing to clearly indicate the card is different from the indicia 36 on the back of the playing cards 38 used during the game. The playing cards 38 are a standard deck having values indicated on the face 39 of each card. On the face of the HULA card 40, as shown in an embodiment in FIG. 2B, a title 44 may be provided indicating the card is a HULA Card, the name of the HULA Action 46 of the card and the Action Element 48 which provides the instructions that must be followed to alter game play are shown. An Activation Code 50 on the HULA Card 40 provides an indicator in the form of a letter or number that tells the user when the HULA Card 40 may be used during play.

Unless otherwise indicated by the Activation Code 50 or based on the sequence of play or HULA Cards 40 in play, a HULA Card 40 may be played during any round. HULA Cards 40 that are marked with an Activation Code 50 using an A as an example or other indicia on the card, such as in the bottom right corner of the card signify that the HULA Card 40 can be played at any time. If a HULA Card 40 is marked with an Activation Code 50 of 3P or otherwise identified as requiring at least three (3) Players, then there must be at least three (3) Players still active in the hand. If there are two or fewer Players, a HULA Card 40 marked 3P may not be played in that hand. In the preferred embodiment, a HULA Card 40 with an Activation Code 50 of F, T, or R can only be played during the Flop, Turn, or River rounds, respectively.

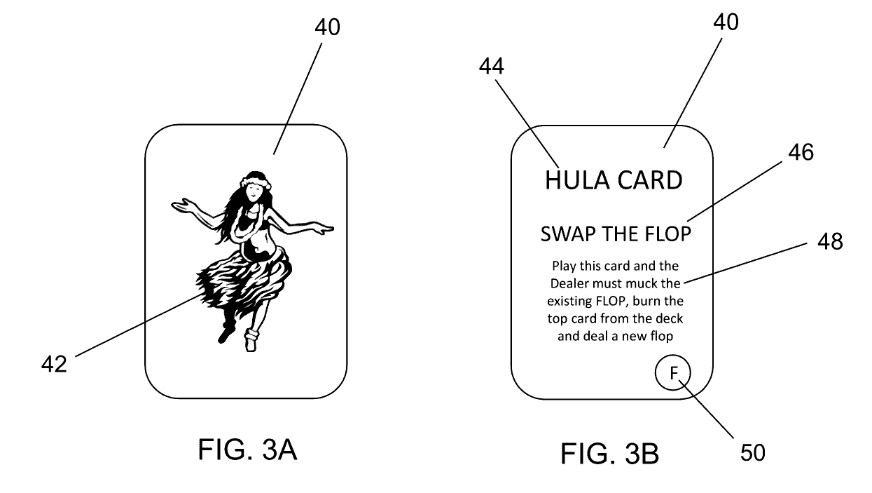

In the preferred embodiment, a Player is not required to play their HULA Cards 40, but once a Player decides to use a HULA Card 40, the decision may be irrevocable. By playing the HULA Card 40, the Player of the card must execute the instructions of the Action Element 48 to alter game play, and then play their hand (fold, call or raise). Each HULA Card 40 that is played must be played and fully executed, before another HULA Card 40 can be played during one turn, and before the Player's bet is placed. A Player may not play one HULA Card 40, place a bet, and then play a second HULA Card 40 during the same turn. A further embodiment of a HULA Card 40 is shown in FIG. 3A with the back of a HULA Card 40 having a design or drawing to show the HULA Card 40 is different from the playing cards 38. An example of a HULA Action 46 having the name Swap the Flop is shown with the Action Element 48 providing the instruction that requires that when the HULA Card 40 is played the Dealer is forced to muck the existing three cards of the Flop, burn the top card of the playing card deck and re-deal three cards for the Flop. The Activation Code 50 at the bottom right hand corner of the HULA Card shows an F indicating that the card may only be played during the Flop round of play. After the Dealer performs the Action Element 48 that alters game play, play then moves to the Player that is next to act in the natural order of play (and does not pick up with a recipient of a HULA Card 40 unless that Player is the next to act in the natural order of play). Following two hands of play, the un-played HULA Cards 40 are mucked, and Players receive two (2) new HULA Cards 40. Play then continues until a victor is declared.

While the vast majority of HULA Cards 40 must be played at the beginning of a Player's turn, there may be some exceptions. These exceptions preferably include the Triplets card, the Buzzer, and the Re-Get-In. Rules and Action Elements 48 for each of these steps are further explained hereinafter.

Finally, in the preferred embodiment, when the competition at the table 10 comes down to the last two Players meaning that the other players have run out of chips and been eliminated or have chosen not to continue playing the Showdown begins. For the Showdown, any remaining active HULA Cards 40 are mucked, and the following HULA Cards 40, if in the Hula deck, are pulled from the deck and removed from play for the Showdown rounds: Go Fish, Jack Off, King Me, Reach Around, Seatbelt, Re-Get-In, Triplets and Wife Swap. Each of the remaining two Players is dealt two new HULA Cards 40 from the revised HULA deck, and play continues through the Flop, Turn and River rounds of betting and through as many hands as are required until one of the two remaining Players wins all of the chips and is declared the winner.

In other embodiments and variations to the rules, a HULA Card 40 may be dealt into the pot 52 by the Dealer during any one or more rounds of betting or may be dealt into the pot 52 when these HULA Cards 40 are removed from the HULA deck prior to the Showdown, as outlined above. The HULA Card 40 may be dealt into the pot 52 prior to or after the two new HULA Cards 40 are to be dealt to the Players at this point. In some variations to the rules one HULA Card 40 may be dealt to or placed in each pot 52, and the winner of each pot 52 wins the included HULA Card 40. There is no limit to the number of HULA Cards 40 a single Player may hold during the final Showdown, just as there is no limit to the number of HULA Cards 40 a Player may play sequentially during a round and/or during a hand.

A list of an embodiment of HULA Actions 46 with the name of each HULA Action 46 and a description of the instructions for the Action Element 48 that must be taken to alter game play follows:

3-Card Monty: When this HULA Card 40 is executed by a Player, the Dealer deals the Player a third Hole card to use. The Player may only use one, or two, of their Hole cards for their final hand though. Player may not use all three Hole cards to make their final hand. The Activation Code 50 is A meaning this HULA Card 40 may be played at any time.

Back to the Future: When this HULA Card 40 is executed by a Player a Player may retrieve their last bet from the pot 52. This HULA Card 40 can be played to retrieve a bet of any size, including “All In”. The Activation Code 50 is A meaning this HULA Card 40 may be played at any time.

Buzzer: This HULA Card 40 voids any HULA Card 40 that another Player has executed. This is the only HULA Card 40 that may be used out of turn, but must be played right on the heels of the opposing Player introducing their HULA Card 40. The Buzzer! HULA Card can only be played if the Player is still involved (not from a folded position). The Buzzer can be played even if the Player is not directly affected by the first HULA Card 40. The Activation Code 50 is A meaning this HULA Card 40 may be played at any time.

Cap it: This HULA Card 40 allows the Player to declare the betting for this round to be capped meaning no bets within the round can exceed a set amount which is whatever amount the Player of this HULA Card 40 wishes to set it at. The Player executing this HULA Card 40 must still call any bets on the table, and cannot reduce the bet. Any Player who follows must also call the Capped bet in order to stay In. The Activation Code 50 is A meaning this HULA Card 40 may be played at any time.

Don't Mind If I Do: The player who plays this card may help themselves to any Board Card at any time. The player chooses the card and makes their new hand, discards one of their three hole cards, and a new Board card is dealt from the deck. Play then resumes. Activation Code 50 is 3P meaning this HULA Card 40 may only be played if there are at least three (3) Players still active in the game.

Fast Forward: The Player that executes this HULA Card 40 is given a sneak peek at whichever of the Flop, Turn, or River cards is to play next, before the Dealer reveals them to the other Players at the table. Sneak peek is not transferable. The Activation Code 50 is A meaning this HULA Card 40 may be played at any time.

Go Again: The Player that executes this HULA Card 40 mucks their Hole cards, and draws two new Hole cards randomly from the deck. The Activation Code 50 is A meaning this HULA Card 40 may be played at any time.

Go Fish: Player that executes this HULA Card 40 asks one other active Player still involved for a specific card, as in the game of the same name. If they do not have the requested card, then the HULA Card Player must “Go Fish” from the deck, make their hand, and then discard one of their now three Hole cards. If the requested card is produced by the asked Player, then that Player, now holding one card, must “Go Fish” from the deck, to retrieve a second Hole card. The Activation Code 50 is 3P meaning this HULA Card 40 may only be played if there are at least three (3) Players still active in the game.

Grave Robber: This HULA Card 40 allows the Player to retrieve one of the “Dead Soldiers” (folded cards) of a Player who has already folded. Their folded cards are placed side by side, face down, and the Grave Robber chooses one, makes his hand, and discards a Hole card. The Activation Code 50 is A meaning this HULA Card 40 may be played at any time.

Jack Off: Playing this HULA Card 40 requires that any active Player at the table 10 who is holding a Jack must offer it for the taking. The Jack Off Player gets to choose which of the proffered Jacks at the table to take. The Jack is exchanged with a Hole card of the Jack Off Player's choosing. After the Jack Off Player takes the Jack, the Player giving up the Jack draws a card from the deck. Any remaining Jacks that have been offered are returned to the Player that offered the Jack. If no active Player at the table has a Jack, then the Player draws a card from the deck, makes their hand, and discards one of their Hole cards. The Activation Code 50 is 3P meaning this HULA Card 40 may only be played if there are at least three (3) Players still active in the game.

King Me: Playing this HULA Card 40 requires that any active Player at the table who is holding a King must offer it for the taking. The King Me Player gets to choose which of the proffered Kings at the table to take. The King is exchanged with a Hole card of the King Me Player's choosing. After the King Me Player takes the King, the Player giving up the King draws a card from the deck. Any remaining Kings that have been offered are returned to the Player that offered the King. If no active Player at the table has a King, then the Player draws a card from the deck, makes their hand, and discards one of their Hole cards. The Activation Code 50 is 3P meaning this HULA Card 40 may only be played if there are at least three (3) Players still active in the game.

Last Ditch: Playing this HULA Card 40 causes the Dealer to muck the existing River (Fifth Street Card), burn the top card from the deck, and deal a new River card. The Activation Code 50 is R meaning this HULA Card 40 may only be played during the River round.

More or Less: The Player that executes this HULA Card 40 may add or subtract a single digit (1) to either of their Hole cards to make their hand. Playing this card does not obligate them to do so, in case the Player wished to use it to bluff. The More or Less card may not be applied to cards on the Board, and may not be used to change the suit of a card. The Ace card may be added to, to become a two (2), or be subtracted from to become a King. The addition or subtraction must be declared when this HULA Card 40 is played (similar to the procedure in playing every other HULA Card 40) during active play, and not at the time of the reveal during the Showdown. The Activation Code 50 is A meaning this HULA Card 40 may be played at any time.

Mulligan: Playing this HULA card 40 gives each of the remaining active Players an additional Hole card to make their hands with. Players must make their new hand and discard one Hole card before betting resumes. The Activation Code 50 is A meaning this HULA Card 40 may be played at any time.

My New Suit: This HULA Card 40 allows the Player that executes this HULA Card 40 to change the suit of either of their Hole Cards to make their hand. My New Suit cannot be applied to cards on the Board, and cannot change the face value of a card. As with the More or Less card, playing the card does not require the Player to follow through with a suit change, if they choose to bluff with it instead. Must be declared (like every other HULA Card 40 as noted above) during active play, and not at the time of the reveal during the Showdown. The Activation Code 50 is A meaning this HULA Card 40 may be played at any time.

Overtime: Once a player plays this card, the Dealer knows to deal a Board card after the River round giving all of the active players at the table a chance to use the additional Board card to bet in an Overtime round. The Activation Code 50 is A meaning this HULA Card 40 may be played at any time.

Reach Around: The Player that executes this HULA Card 40 must Reach Around the active Player ahead or behind them, and exchange their two Hole cards with the next active Player (either two (2) seats in front, or two (2) seats behind them, but can be more, depending on number of folded Players still at the table). The Reach Around is executed blindly, and cannot be unconsummated once played. The Activation Code 50 is 3P meaning this HULA Card 40 may only be played if there are at least three (3) Players still active in the game.

Re-Get-In: This is the only HULA Card 40 that can be played from a folded position, and can be played out of turn, immediately following the reveal of Board cards (see below). If a Player has been “out” for no more than one round, then they may Re-Get-In by playing this HULA Card following the reveal of the Flop, Turn, or River, and return to an active position. This card may not be played if a Player has been out for more than the revelation of any one of the Flop, Turn, or River. The Activation Code 50 is A meaning this HULA Card 40 may be played at any time.

Seatbelt: This HULA Card 40 may be given to any single active Player at the table 10. The recipient of the Seatbelt now finds themselves “strapped to the table” and unable to fold for the entire hand. Instead, they must call all bets. Though the recipient may not fold, they are free to raise the action if they so choose. The Activation Code 50 is 3P meaning this HULA Card 40 may only be played if there are at least three (3) Players still active in the game.

Sit This One Out: Playing this HULA Card allows a Player to skip all betting for the round. They may not bet at any point in the round that they are Sitting Out, but they remain active, and “In”. Player must return to active betting the following round, or fold. Must ante or have anted at some point in play in order to re-enter. Player may not Sit Out the River betting. The Activation Code 50 is A meaning this HULA Card 40 may be played at any time.

Stop Drop and Roll: Playing this HULA Card 40 suspends play and forces all active Players to first pass one of their respective Hole cards to the next active Player behind them. The first card must be passed before looking at the new Hole card they are being given. Players then make note of their new hands, and must once again pass a second Hole card to the next active Player behind them. At this point, betting resumes. Players may not fold in the middle of exchanging the Hole cards. The Activation Code 50 is A meaning this HULA Card 40 may be played at any time.

Swap the Flop: Playing this HULA Card causes the Dealer to muck the existing Flop, burn the top card from the deck, and deal a new Flop. This HULA Card cannot be played following the showing of the Turn card. The Activation Code 50 is F meaning this HULA Card 40 may only be played during the Flop round.

Triplets: This HULA Card 40 plays out of turn at the time HULA Cards are dealt or may also be played during the normal course of play. This HULA Card is exchanged with the Dealer for two additional HULA Cards, giving the Player three HULA Cards to play. The Activation Code 50 is A meaning this HULA Card 40 may be played at any time.

Turn-it-up: This HULA Card 40 may be given to any single active Player at the table 10. The recipient of Turn-It-Up HULA Card must play the hand with one of their Hole cards facing up for the table to see. The recipient decides which of their cards to show. The Activation Code 50 is A meaning this HULA Card 40 may be played at any time.

Turn Over: Playing this HULA Card 40 causes the Dealer to muck the existing Turn card (Fourth Street card), burn the top card from the deck, and deal a new Turn card. Cannot be played following the showing of the River card. The Activation Code 50 is T meaning this HULA Card 40 may only be played during the Turn round.

Wife Swap: Playing this HULA Card 40 requires that any active Player at the table 10 who is holding a Queen must offer their Queen for the taking. The Wife Swap Player gets to choose which of the proffered Queens at the table to take. The Queen is exchanged with a Hole card of the Wife Swap Player's choosing. After the Wife Swap Player takes the Queen, the Player giving up the Queen draws a card from the deck. Any remaining Queens that have been offered are returned to the Player that offered the Queen. If no active Player at the table has a Queen, then the Player draws a card from the deck, makes their hand, and discards one of their Hole cards. The Activation Code 50 is 3P meaning this HULA Card 40 may only be played if there are at least three (3) Players still active in the game.

Following is a description of the variation in play to the setup and rules of Texas Hold 'Em using the HULA Cards 40 with this new version of the game referred to herein as HULA Poker.

### Choosing a Dealer

Choosing the Dealer is similar to a standard game of Texas Hold 'Em with either dealing a card to every Player, or spreading the cards out face down on the table and each Player choosing one. The Player with the highest-valued card (aces are high for selecting a Dealer) starts as the Dealer. A Dealer button or other indicator may be placed in front of the Player chosen as the Dealer with the task of dealing and Dealer button being transferred to the Player to the left of the Dealer at the end of the hand.

### Putting Out the Blinds

Similar to a standard game of Texas Hold 'Em, after a Dealer is chosen, the two Players to the left of the Dealer need to put out the blinds with the Player directly to the left of the Dealer putting out the small blind and the Player to the left of the small blind putting out the big blind which is exactly, or conveniently close to, double that of the small blind.

### Game-Play and Betting Rounds

The Player dealing the cards deals to the left of the Player with the Dealer button first, rotating around the table in a clockwise manner, giving each Player one card at a time until each Player has two cards, the Player's Hole cards. Similar to Texas Hold 'Em a hand of HULA Poker consists of a minimum of one and a maximum of four betting rounds with the opportunity to play certain HULA Cards 40 during these rounds. A hand ends when all Players but one have folded, with the last Player remaining claiming the pot, or if after the fourth and fifth betting rounds are completed and multiple Players still remain in the round then the cards are revealed and the Player with the highest hand claims the pot. If at any point a Player bets all of their chips by placing them into the pot and then losing the hand, they must leave the game. In some embodiments, the game rules may provide for a re-buy of chips through the earlier rounds to allow a Player to re-enter a game. If the re-buy option is not available, the losing Player must remain out of the game. When only two Players remain, the Players at this point enter into the Showdown. For the Showdown, all of the previously dealt HULA Cards 40 are gathered and the following HULA Cards 40 are removed from the HULA Deck: Go Fish, Jack Off, King Me, Reach Around, Seatbelt, Re-Get-In, Triplets and Wife Swap. Each of the remaining two Players is dealt two new HULA Cards 40 from the revised HULA deck, and play continues.

### Pre-Flop

When all Players receive their Hole cards, the Pre-Flop betting round begins. Each Player must look at their cards and decide what action they would like to take. In HULA poker, similar to Texas Hold 'Em, only one Player can act at a time. The Pre-Flop betting round starts with the Player to the left of the big blind. This Player has four options:

HULA Card: The Player may use one of their HULA Cards (as described herein).

Fold: The Player may pay nothing to the pot and throw away their hand, waiting for the next deal to play again. In HULA Poker when a Player folds, the Hole cards are placed on the Coaster 22 in front of that Player and the Red Cup 20 is flipped upside down and placed on top of the Coaster 22 and the indicator signal 32 is activated, showing that a particular Player is associated with the folded cards and may reenter play and participate in the hand if a HULA Card 40 comes into play in later rounds.

Call: The Player matches the amount of the big blind.

Raise: The Player raises the bet by doubling the amount of the big blind. A Player may raise more if they choose.

Once a Player has made their action, the Player to the left of them gets their turn to act. Each Player is given the same options: to play a HULA Card 40, fold, call the bet of the Player to their right (if the previous Player raised, that is the amount the Player must bet to call) or raise.

### The Flop

Once the Pre-Flop betting round ends, the Flop is dealt. This is done by dealing the top card in the deck face down on the table (it becomes the burn card), followed by three cards face up. Once this has been dealt, the first Post-Flop betting round begins. The rules of a Post-Flop betting round are the same as a Pre-Flop, with two small exceptions: The first Player to act is the next Player with a hand to the left of the Dealer, and that Player may use a HULA Card, check or bet; as there has been no bet made, checking is free. During the Flop in HULA Poker a Player may for example play the Swap the Flop which causes the Dealer to muck the existing Flop, burn the top card from the deck, and deal a new Flop. Then the Flop betting round begins with a bet on the Flop being at a minimum equal to the amount of the big blind.

### The Turn

Once the betting round on the Flop completes, the Dealer deals one card facedown (burn card) followed by a single card face up, the Turn or Fourth Street card, also known as the “burn and Turn.” During the Turn a Player may play the Turn Over HULA Card that causes the Dealer to muck the existing Turn card (Fourth Street card), burn the top card from the deck, and deal a new Turn card. Then once the new Turn has been dealt, the third betting round starts. The third betting round is identical to the Flop betting round.

### The River

Assuming more than one Player is left, having not folded on one of the previous streets, the River is now dealt. Dealing the River or Fifth Street card is identical as dealing the Turn, with one card being dealt facedown, followed by a single card face up. The Last Ditch HULA Card may be played which causes the Dealer to muck the existing River, burn the top card from the deck, and deal a new River card. Then the River betting round begins which is identical to the betting round on the Turn.

### The Reveal

Once the River betting round has been completed, the Players now reveal their hands to determine the best hand and that Player wins the pot. The rules for revealing the hands in HULA Poker are the same as Texas Hold 'Em which are as follows: The Player who bet on the River is the default first Player to reveal their hand. If any other Players choose to show their hand first, that is OK. If no betting happened on the River (all Players checked), the Player closest to the left of the Dealer must open their hand first, continuing clockwise around the table. During the reveal of hands, no HULA Cards 40 may be played. In the event a Player is holding a losing hand, it is their option to reveal their cards or simply muck their hand and concede the pot.

### Elimination

If a Player bets all of their chips on a hand and loses, that Player is eliminated from the game. Depending on the rules of play, the Player may have an option to Re Buy and reenter the game by buying more chips or remain out of the game. As each hand is played and Players are eliminated the remaining Players continue until only two Players have chips and can remain in the game.

### Showdown

When all other Players have been eliminated and only two Players remain in the game, the Showdown begins by gathering all remaining HULA Cards 40 from every Player and removing the Go Fish, Jack Off, King Me, Reach Around, Seatbelt, Re-Get-In, Triplets and Wife Swap HULA Cards 40 from the HULA Deck. The two remaining Players are dealt two new HULA Cards 40 and the same rounds of betting, the Pre-Flop, the Flop, the Turn and the River are played within each hand. A Player may play a HULA Card 40 during the Showdown for example the More or Less HULA Card 40 may be played that allows the Player executing the HULA Card Action Element 48 to add or subtract a single digit from one of their Hole cards which may turn a losing hand into a winning hand. Other HULA Cards 40 may be played during the Showdown to affect the outcome of play and which Player will be the winner. When the River round is completed, the Player who bet on the River reveals their hand first or if no betting happened on the River (the two Players checked), the Player closest to the left of the Dealer opens their hand first, and the winning hand takes the pot 52. The winner is declared when one Player wins all of the others Player's chips.

### HULA Card Play Examples

The HULA Cards 40 may introduce many variations in play that change the course of action of the game and provide for a novice player to even the playing field with an experienced Texas Hold 'Em player. A Player's hand of winning cards may be changed through a sequence of playing HULA Cards 40 as shown in the following examples that demonstrate the use of HULA Cards 40 in play and the resulting actions and effects during play:

For example, if Player 1 has executed a 3 Card Monty HULA Card and is therefore holding three Hole Cards, and Player 2 hits Player 1 with a Reach Around, then Player 1 must lay all three of his or her Hole cards face down, from which Player 2 must pick two of the Hole Cards. Player 1 now has a new 3 Card Monty Hand consisting of the Reach Around Player's old hand plus their remaining leftover Hole card.

In another example, if Player 1 has declared a My New Suit HULA Card or a More or Less HULA card, and Player 2 hits Player 1 with a Reach Around, then Player 2 only receives the face value of the Hole cards from Player 1. The My New Suit HULA Card or the More or Less HULA Card do not transfer to Player 2. Player 1 may still perform the My New Suit HULA Card or More or Less HULA Card upon their new hand.

Some additional terms specific to HULA Poker that may be encountered during game play are as follows:

Coaster: Sensor at the table of play that is covered or uncovered by the Red Cup marker, to mark a Player as “In” or “Out” of the hand after they have folded their cards.

HULA Card: See HULA Cards descriptions.

Red Cup: A cup, marker or token 20 that may be of ceramic, plastic, or another material that is used in conjunction with the Coaster 22 to indicate whether a Player is “In” or active within a round of play or “Out” and non-active within that round. The Red Cup 20 and Coaster 22 system is used to tether a Player to the cards of their hand in the event of their folding.

Using HULA Cards also provides for variations at all levels of play where HULA Poker may be easily learned and played by a group of friends at home, be played in a casino or through a multiplayer internet connection or in a further variation provide for audience participation to decide which HULA Cards 40 are played and when during a televised or internet gaming event.

### Cardroom Table/Home Play

Perhaps the most traditional of the platforms for which HULA Poker has been designed, is the traditional Home Game, to be played and enjoyed casually, amongst friends, in a home setting. In the preferred embodiment, the user is supplied with the apparatus and items required to alter the methods of playing Texas Hold 'Em to playing the novel game of HULA Poker. Such may include decks of HULA Cards 40 and the equipment required in order to start play with other Players—including the Red Cups 20, Coaster 22, and a Counter 34 or other control board 24 or other controller device such as a smartphone using a mobile software application that keeps track of Player participation the number of times a Player folds during a game.

### Casino Play

In another embodiment of the physical card game, Casino Play, the method and system includes a casino gaming table specifically designed for HULA Poker, with a plurality of Player locations 12 and designated Dealer Seat 14, along with the Red Cup and Coaster System 20 and 22 described earlier, and further illustrated in FIGS. 1A and 1B. There may also be systems allowing for Audience Participation during play as described herein, at the discretion of the casino.

### Online Streaming of Play

In another embodiment of the present invention, a HULA Poker game is presented as content streamed online, with which an audience may interact. The exhibition of play online will allow for the incorporation of Product Placement and Integration into the game.

### Television

Similar to the online streaming of play, the Television Platform allows the growth and cultivation of an audience by exposing the game to as many potential Players as possible. The episodes of television will consist of segments edited together from the footage of the various tournaments that will be streamed online at considerably less cost than the creation of traditional television, supplemented with various interstitials to include, but not be limited to promotional spots, sketch comedy, musical interludes, table talk segments, visiting celebrity pieces, explanations and visualizations of rules, action elements and outcomes and running commentary on game play via traditional announcers.

### Audience Participation and Viewer Activation

The present invention also comprises novel methods and systems for enabling one or more persons viewing a HULA Poker game to participate in or influence the play of the game, which is referred to as a Viewer Activation.

In the instance of the HULA Game taking place within a Casino Gaming Event with a live audience, before a Webcast audience, or the Live Streaming of the HULA Game event, or an online HULA Poker game event, the play and outcome of the game may be effected actively by the audience (which in one embodiment is by audience popular vote) and/or passively (which in one embodiment is by audience head count) through the host and host system (which may be the producer or sponsor of the event, the Dealer or other person or entity providing the webcast, streamed or online event).

In one embodiment of Audience Participation being effected actively, the Audience is presented with voting choices during any given round of play, and the audience can vote on the desired outcome, such as by clicking an onscreen box with their cursor or otherwise registering an electronic vote with the host. The option to activate a HULA Action Command 68 or HULA Command that has received the most votes is then put into play by the host at the appropriate stage of play.

In one embodiment of audience participation being effected passively, audience participation is effected when the total count of audience members has reached a certain threshold. Passive audience participation may be desirable for “rewarding” the audience for “tuning in” to the event or to maximize the drama of the event as the audience grows. In such an embodiment, the host system will monitor and count the number of people viewing at any given time. No audience votes are required, no choices are presented.

In another embodiment of a live HULA Poker event with a live in-house audience, (which in one embodiment is taped for later broadcast or rebroadcast), only Active Audience Participation is enabled, with the audience voting from electronic devices (such as smartphones, tablets, game controllers or other suitable devices or apparatus) located at their seats or positions. In a variation of this embodiment, the host and/or host system can activate what otherwise would have been passive audience participation at seemingly random, but pre-determined by the host, moments in play, designed to maximize their dramatic impact.

In the two exemplary embodiments of methods in which Viewer Activation is initiated by the Popular Vote and the Head Count in an exemplary Online Streaming scenario, a broadcast of a HULA Game is initiated from a host broadcast system, such as a host computer system. The host system may elicit participation by the viewer(s) using any known query-response method, including by way of example a point and click menu system. The host system may broadcast questions to be displayed on a television or computer screen, or by a communication to the viewer's communications device, such as a desktop or laptop computer, a tablet computer, a cellphone or other such personal electronic device. A Viewer Activation may be triggered based upon predetermined criteria, such as by tabulating viewer responses, or by monitoring the viewing numbers.

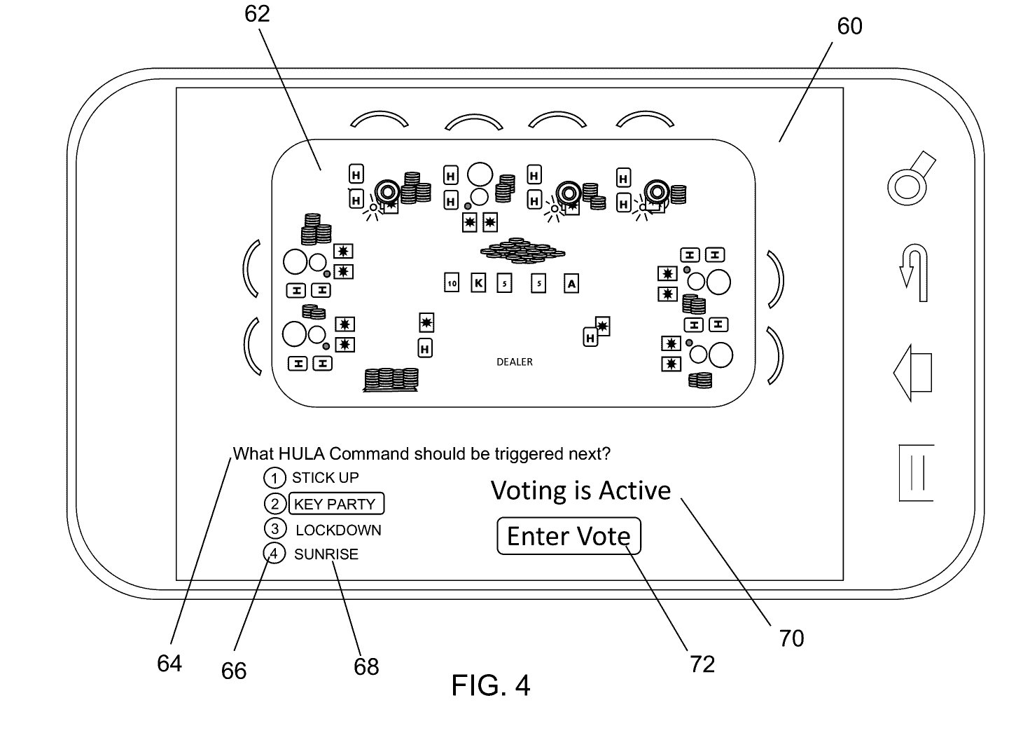

In the embodiment in which a Viewer Activation can be triggered by Popular Vote, the viewer(s) may be presented a question, such as a multiple choice question, that appears, as shown in FIG. 4 on the viewer's screen 60 while watching the HULA Game event 62, such as along the bottom of the viewing screen, although it is not limited to this specific geography. The question 64 may appear in the form of, but is not limited to: “What HULA Command should be triggered next?” Below the question 64 will be a plurality of buttons or menu items 66, each one identifying a different options for HULA Commands 68 for the viewer to select. For example, option 1 could be the STICK UP, option 2 the KEY PARTY, option 3 the LOCK DOWN, and option 4 the SUNRISE. The viewer is then able to vote during a window of opportunity when an indicator 70 notes “Voting is Active” and by selecting the option for the HULA Command 68 they most wish to see, such as by clicking on the indicia for the desired option and selecting a button 72 to enter their vote. The host system tabulates the results once the voting has closed, and the HULA Command 68 with the most votes is set into motion. HULA Commands 68 through Viewer Activations that are triggered by Popular Vote will be marked with an Activation Code 50 of PV in the HULA Command 68 descriptions below.

In another embodiment, a HULA Command 68 through Viewer Activation can be triggered by Head Count. Head Count Triggering is passive on the part of the Audience, but once the host system has determined that a certain pre-arranged number of cumulative viewers have tuned in to the streaming, a Head Count Activation is triggered. For example, once the 5,000^{th} viewer tunes into the stream, the host system automatically triggers the STICK UP HULA Command 68 for that hand. The criteria to trigger a Head Count Activation can be any indicia of a viewer attribute. Head Count Activations triggered by viewer threshold numbers being reached will be marked with an Activation Code 50 of HC in the in the HULA Command 68 descriptions below.

It will be appreciated that the methods for triggering Viewer Activation are not mutually exclusive, and several different Viewer Activation criteria may be applied to the same hand or game. In one embodiment, a Viewer Activation may trigger a HULA Command 68 at any point during any round. Viewer Activations that may be initiated at any point of the HULA Poker Game are HULA Commands 68 that are marked or identified with an Activation Code 50 of an A or other indicia to signify that they can be implemented any time. A HULA Command 68 through Viewer Activation marked with an Activation Code 50 of either F, T, or R can only be played during the respective Flop, Turn, or River rounds.

In a Viewer Activation system, there may be HULA Commands 68 which can only be triggered if there are a predetermined number of remaining Players—for example four (4) Players. In such an embodiment, if a particular HULA Command 68 is identified or marked with an Activation Code 50 of 4P or otherwise designated to require at least 4 remaining Players, then there must still be 4 Players still active in the hand. If there are three or fewer Players, a Viewer Activation requiring 4 Players is not to be triggered unless and until the next hand of cards is dealt, and then it is to be activated as soon as is feasible during that next round. If such a set of circumstances were to arise, then the Dealer should not give advance warning that there has been a Viewer Activation triggered, until such time as it is put into play. For example, if there are only two active Players during a round, but the audience triggers the Key Party HULA Command 68, this does not play until the next round. The Dealer should not make an announcement that the “Key Party” is being activated next round, but instead should allow the current active Players to conclude the current hand, deal the next hand, and before betting begins, announce the Key Party activation. At which point the Key Party actions are to be undertaken by the active Players, and play can then resume.

In one alternative embodiment, once a Viewer Activation has been triggered, the triggered event is irrevocable, and cannot be undone by the Players or the Dealer. By triggering a Viewer Activation, the audience disrupts the flow of play. The Dealer stops play at an appropriate moment to inform the Players that there has been a Home Viewer Activation triggered by the audience. The Dealer will then announce the HULA Command 68 required by the Home Viewer Activation, and take the steps required by the HULA Command 68 and then play resumes where it left off. The round does not pick up from the beginning again, nor does the direction of play change

The following is a description of HULA Commands 68 that are triggered by exemplary Viewer Activations and the Activation Codes 50 indicating when these commands may be taken during the HULA Poker gaming event:

Alarm: When the ALARM HULA Command 68 is triggered, a siren sounds (and optimally, a red light flashes) and the deal is frozen at whatever point it has reached, with no further cards to be dealt. For instance, if the Alarm is triggered after the Flop, but before the Turn, then the entirety of the betting for the hand is based on the hand Players can make without a Turn or River card ever dropping. Whatever cards have been shown are all the cards that will be available to Players to make a hand. An ALARM HULA Command 68 may not be triggered Pre-Flop. The Activation Code 50 for this HULA Command 68 is PV, HC/T, R meaning the HULA Command 68 may be triggered by Popular Vote or Head Count and may occur only during the Turn or River rounds.

Boil the Lobster: In the world of Texas Hold 'Em Poker, a Player who sits at the table folding over and over, trying to wait the rest of the table out by not engaging in active betting is known as a “Lobster”. BOILING THE LOBSTER is a HULA Command 68 triggered by a Viewer Activation that allows the Audience to punish a Player for boring play. Once a Player has not managed any action for five consecutive hands, then they earn the moniker of Lobster, and are eligible for “Boiling”. It is the job of the host to track the betting activity of each Player using the Counter 34, and once this threshold of inactivity has been reached, the Host will then ask the Home Audience, in the form of a Yes or No question, whether or not they want to BOIL THE LOBSTER? The audience votes by clicking the Yes button, or the No button, and the votes are tabulated. If the vote is No, the Lobster may be presented for Boiling every hand until they bet, breaking the cycle. If the vote is Yes, then the next hand of play, the designated Lobster must call every bet the following round, and cannot fold, similar to the SEAT BELT HULA Card 40. The Activation Code 50 for this HULA Command 68 is PV/A meaning the HULA Command 68 may be triggered by Popular Vote and may occur at any time during the game.

Doorbell: When the DOORBELL HULA Command 68 is triggered by Viewer Activation, the viewers at home are invited to vote to pick a Player for whom they will collectively play their next hand. This is one of the more labor-intensive of the Home Viewer Activations, but also one of the most engaging. During play, the Host presents the Doorbell HULA Command 68 for Viewer Activation either alongside other choices for Popular Vote, or by pre-determined Head Count. Once activated, the Host must then present all active Players to the Viewing Audience to vote to see whose hand they wish to collectively play next round. The names of each Player each get an option button displayed, and the audience votes for their choice by clicking on the button bearing their name. The Host tabulates the votes, and then, following the Opening Deal of the next hand, before any action gets underway, the Dealer informs the chosen Player that they are the recipient of the Doorbell, and that the home viewing audience will be playing this round for them, with that Player's chip stack at stake. For every decision to be made, the Host will present three options—Check, Fold, or Bet, and viewers will vote for the option they like best by clicking on the appropriate button. Votes are tabulated by the Host, and if “Bet” is the winning option, the Host then presents three amounts for the audience to select from. The amounts will vary, and are not limited to any one amount. Once the amount is selected, then the Dealer informs the Player how much of his money he has to put into the pot, and the Player counts out the chips themselves, without knowing what their hand is, and pushes them into the middle. The hand is played out in this manner until the betting concludes and the Players show their hands. Players may not override the Home Viewing Audience's decisions during this hand, no matter what they vote to do. The Activation Code 50 for this HULA Command 68 is PV, HC/A meaning the HULA Command 68 may be triggered by Popular Vote or Head Count and may occur at any time during the game.

Down Flop: Triggering this HULA Command 68 by Viewer Activation causes the Dealer to deal the first card of the next Flop face down, though it remains active. Players must play out the entirety of the hand with that card down, the DOWN FLOP. The Down Flop card is revealed at the end of the hand, when all of the betting is complete. The Activation Code 50 for this HULA Command 68 is PV, HC/A meaning the HULA Command 68 may be triggered by Popular Vote or Head Count and may occur at any time during the game.

Follow the Lady: When this HULA Command 68 is triggered by Viewer Activation, the card following the next Queen that shows on the board is declared Wild for that hand. For example, if the Flop shows to be Q-K-9, then Kings are Wild for that hand. If the Turn is a Queen, then the River card will be Wild. If a Queen does not show during the Hand in which the FOLLOW THE LADY is activated, then the HULA Command 68 stays “live” through as many hands of Poker as it takes until one does appear. If the Queen first shows on a River card, then the first card of the next Flop is deemed to be Wild. The Activation Code 50 for this HULA Command 68 is PV, HC/A meaning the HULA Command 68 may be triggered by Popular Vote or Head Count and may occur at any time during the game.

Huevos: Triggering the HUEVOS HULA Command 68 by Viewer Activation introduces a round of betting between each card of the Flop. An actual bet in between each card is not necessary for play to move forward, should the entirety of the active Players at the table decide to check the betting on any given round, but the option to bet on each card remains, meaning that instead of the traditional four rounds of betting per hand (Pre-Flop, Flop, Turn, and River), the round for which Huevos has been activated will have six rounds of betting (Pre-Flop, Flop Card 1, Flop Card 2, Flop Card 3, Turn, and River). The Activation Code 50 for this HULA Command 68 is PV, HC/A meaning the HULA Command 68 may be triggered by Popular Vote or Head Count and may occur at any time during the game.

Key Party: When the KEY PARTY HULA Command 68 is triggered by Viewer Activation, which causes each Player at the table to take out their keys, and put them in a designated bowl. One at a time, beginning with the Player whose turn it is as designated through normal course of play, Players blindly reach into the bowl and extract a set of keys. If a Player should pull their own set of keys, then the keys are returned to the bowl, and the Player pulls again before the bowl proceeds past their position. Once the keys have all been distributed, then each Player shall put the keys on top of their two Hole cards, and pass both keys and the Hole cards to the Player who owns that set of keys (in effect passing that person their hand). Once everyone has retrieved their keys along with the new set of Hole cards, play resumes as if there had been no disruption. That is to say, a round does not recommence for betting, nor does the game begin anew. Players are under no obligation to bet the new hands, and may fold with no penalty. The Activation Code 50 for this HULA Command 68 is PV, HC/A meaning the HULA Command 68 may be triggered by Popular Vote or Head Count and may occur at any time during the game.

Lock Down: When the LOCK DOWN HULA Command 68 is triggered this Viewer Activation acts largely as the HULA Card 40, the SEATBELT, for the remaining active Players. LOCKDOWN forces each remaining active Player into having to call every bet that is made, and none may fold. Players who have folded prior to the activation of the Lockdown, stay folded, although may return to active play if they wish by playing the RE-GET-IN HULA Card 40 under the normal flow of play. The Activation Code 50 for this HULA Command 68 is PV, HC/A meaning the HULA Command 68 may be triggered by Popular Vote or Head Count and may occur at any time during the game.

River Runs Through It: Triggering this HULA Command 68 by Viewer Activation causes the Dealer to deal the next available River card face down, though it remains active. Players must play out the entirety of the hand with that card face down. The River card is then revealed at the end of the hand when all of the betting is complete. The reveal of this activation does not take place prior to the dealing of the River card—the River card is simply dealt face down as the Dealer announces that a RIVER RUNS THROUGH IT. The Activation Code 50 for this HULA Command 68 is PV, HC/A meaning the HULA Command 68 may be triggered by Popular Vote or Head Count and may occur at any time during the game.

Stick Up: The STICK UP HULA Command 68 is a surprise Viewer Activation that does not reveal itself to have been activated until the conclusion of play when a winner of a round has been declared. If the Stick Up has been activated, then the effect is to cause the winner of the round to “stick em up” and be robbed of half the winnings in the pot, which remain there for the next hand. To clarify, if the Stick Up is activated during Hand 1 of play, and the pot gets up to $1,000, then when the pot is won by Player A, that Player forfeits half the pot, in this case being $500, which stays behind in the pot for Hand 2. If the pot of Hand 2 gets up to $1,000+$500 and is won by Player 2, then Player 2 wins the entirety of the pot, in this case $1,500. The Activation Code 50 for this HULA Command 68 is PV, HC/A meaning the HULA Command 68 may be triggered by Popular Vote or Head Count and may occur at any time during the game.

Sunrise: If the SUNRISE HULA Command 68 is triggered by Viewer Activation, then all Players must play with one of their Hole cards facing up for the table to see. The choice of which card to show is at the discretion of the Player. The Activation Code 50 for this HULA Command 68 is PV, HC/A meaning the HULA Command 68 may be triggered by Popular Vote or Head Count and may occur at any time during the game.

Turn Down: Triggering the TURN DOWN HULA Command 68 through Viewer Activation causes the Dealer to deal the next available Turn card face down, though it remains active. Players must play out the entirety of the hand with that card face down. The Turn card is then revealed at the end of the hand when all of the betting is complete. The reveal of this activation does not take place prior to the dealing of the Turn card—the Turn card is simply dealt face down as the Dealer announces TURN DOWN. For purposes of clarifying, it is understood that unless a RIVER RUNS THROUGH IT becomes activated as well, that the River card be dealt face up following the activation of the Turn Down, as is customary. The Activation Code 50 for this HULA Command 68 is PV, HC/A meaning the HULA Command 68 may be triggered by Popular Vote or Head Count and may occur at any time during the game.

Wild Thing: If the WILD THING HULA Command 68 is activated through Viewer Activation, then a Wild Card is introduced into play. Upon the first available opportunity following the conclusion of an active betting round if one is underway at the time of activation, the Dealer is to reveal the next card, without burning, from the top of the deck, and whatever that card is becomes Wild. The Wild Card is then set aside and does not serve as the burn card, if one is needed prior to the dealing of the next round. To clarify, if the Flop is out, and Wild Thing becomes activated, then the Dealer allows the betting for that round to conclude, will then announce Wild Thing, reveal the top card, set the now Wild Card aside, burn the following card, and play the Turn. The Activation Code 50 for this HULA Command 68 is PV, HC/A meaning the HULA Command 68 may be triggered by Popular Vote or Head Count and may occur at any time during the game.

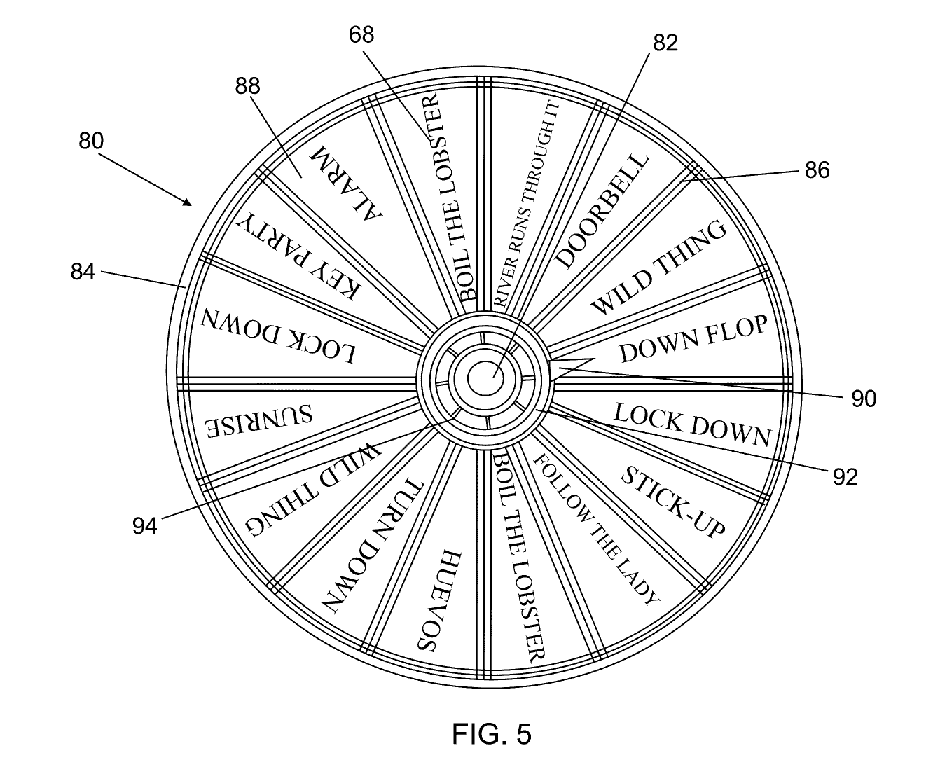

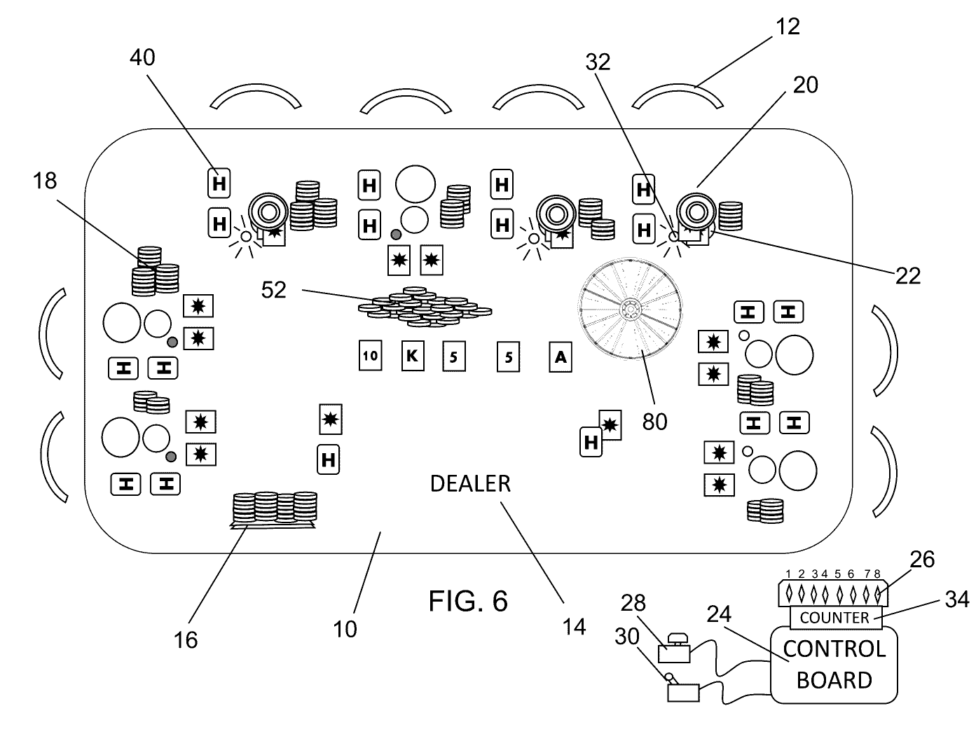

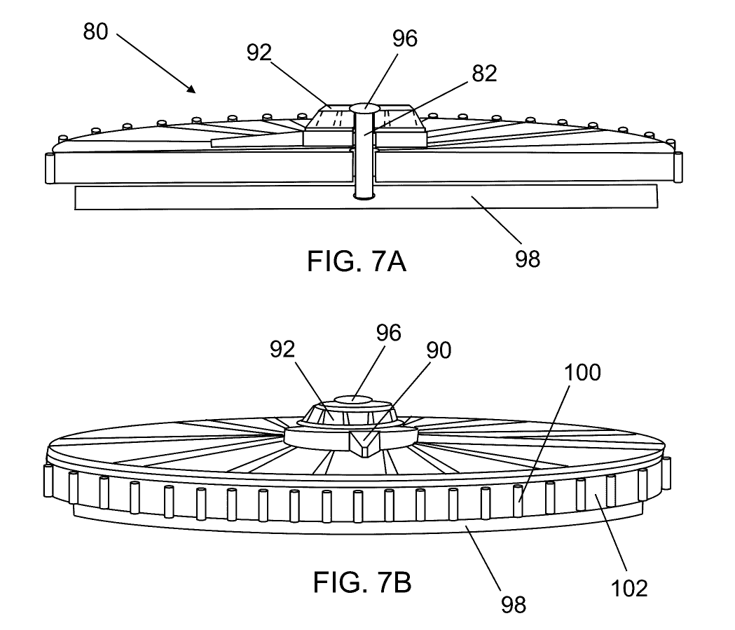

The HULA Commands 68 that may interrupt, change and add variety to play may be available in a number of different formats through tangible, mechanical, electronic, software, or other methodologies to provide for triggering by a player, the dealer 14 or through Viewer Activation. In one embodiment the HULA Commands 68 may be offered as an additional set of playing cards that may be selected during play such as based on the round of play, a preset time limit, the dealing of a particular card, card value or suit for a Flop, Turn or River card, or other rules that pause play until a HULA Command 68 may be selected and the required steps as described above are completed. In some embodiments, the HULA Commands 68 may be provided on an electronic or mechanical wheel that is spun or otherwise activated to create a randomness to the HULA Command 68 selected. As shown in FIG. 5, the HULA Wheel 80 has a spindle 82 that extends through the center of a circular plate 84 that has a series of dividers 86 that separate each identified HULA Command 68 into a series of sections 88 within the plate 84. A pointer 90 is attached to a knob 92 that may have nubs, protrusions, grooves and/or indentions or other contours 94 that provide an uneven surface that can be easily gripped to spin the knob 92 while the HULA Wheel 80 remains stationary to cause the pointer 90 to come to rest on a section of the plate 84 and indicate the HULA Command 68 that must be taken. For example, in a home game played among friends, the HULA Wheel 80 may be of a small dimension of from between 5″ to 12″ and more particularly 8″ in diameter to fit on the table 10 during play as shown in FIG. 6.

In further embodiments, the knob 92 of the HULA Wheel 80 may be affixed to the spindle 82 using a cap 96 or other attachment fixture and the spindle 82 may be affixed to a base 98 that is separated from the circular plate 84 providing for the plate 84 to spin while the pointer 90 is held in place. A number of ridges 100 or handles may be provided around the outer edge 102 of the plate 84 in order to grab and hold the plate 84 and then forcefully rotate the plate 84 of the HULA wheel 80 around the spindle 82. The HULA wheel 80 may be of any design or color and may have flashing lights, various sounds when spinning or landing on a particular HULA Command 68 and may further audibly call out the HULA Command 68 that has been randomly selected to add excitement and suspense to the HULA Game.

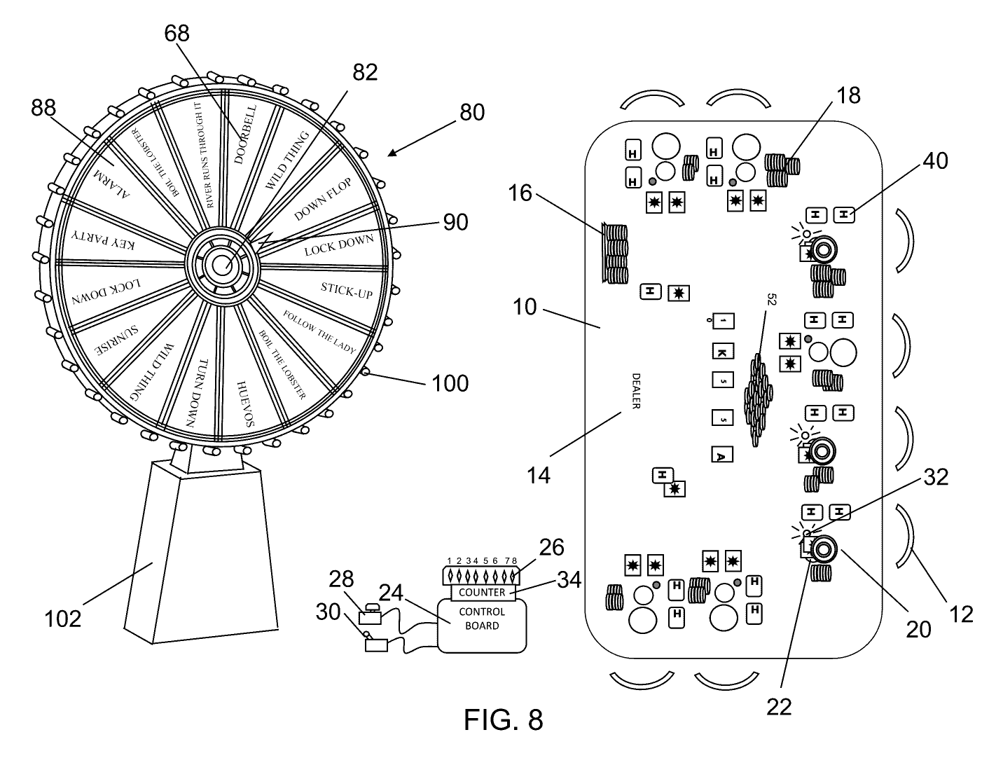

The HULA Wheel 80 may further be of any size and dimension to accommodate the venue of play and the size and number of a live audience. For example, as shown in FIG. 8, a large HULA Wheel 80 may be on a stand 102 and be used within, for example, a casino setting or through an interactive internet connection with for example the Dealer 14 spinning the HULA Wheel 80 when Viewer Activation through Popular Vote, Head Count, or other criteria or circumstance has caused a HULA Command 68 to be triggered. The HULA Wheel 80 may provide for some HULA Commands 68 such as BOIL THE LOBSTER or others to be included in the HULA Wheel 80 more than once to increase the chances that these HULA Commands 68 will randomly be selected more often to further increase the excitement and suspense of the HULA Game. In further embodiments, the HULA Commands 68 may be displayed through an electronic board or other device that provides for the Dealer or Viewer to trigger the device to select the HULA Command 68. The HULA Commands 68 may further be selected using a randomized software algorithm through a mobile app or other electronic selector or be selected through other means of a live action mechanical or electronic control to add randomness to which HULA Command 68 is being selected. In some embodiments, the components of a HULA Poker Game may come in a kit that includes the HULA Cards, a deck of standard playing cards, the rules for Texas Hold 'Em and variations using the HULA Card 40 and HULA Command 68 instructions, the Red Cups 20, Coasters 22, and Counters 34 with the control board 24 and a HULA Wheel 80 or other device to randomly select the HULA Commands 68.

The present invention introduces many unexpected twists and turns into the traditional game of Texas Hold 'Em. The present invention provides for game play in various settings such as a home game among friends, in a casino style event and through interactive audience participation that adds excitement and helps to even the skill level between novice and experienced players. The present invention further provides for a downloadable or web-based software application, a mobile app or a secure restricted access web-site having both play-for-fun and interactive betting for a use to play HULA Poker through an internet connection.

Although specific embodiments of the invention have been disclosed herein in detail, it is to be understood that this is for purposes of illustration. This disclosure is not to be construed as limiting the scope of the invention, since the described embodiments may be changed in details as will become apparent to those skilled in the art in order to adapt the rules, action elements and commands of HULA Poker to particular applications, without departing from the scope of the following claims and equivalents of the claimed elements.

What is claimed is:

1. A poker game as a variation of Texas Hold 'Em poker comprising:
a deck of standard playing cards configured to and following the rules of play to play a game of Texas Hold 'Em poker; and
a plurality of action elements having player executed rules and actions designed to alter the course of play of the Texas Hold 'Em poker game.

2. The poker game of claim 1 wherein the plurality of action elements are in the form of a deck of cards.

3. The poker game of claim 1 comprising:
the plurality of action elements selected from a group consisting of:
an action element requiring the dealing of a third hole card;
an action element requiring the retrieving of a players last bet from the pot;
an action element requiring a player to choose a board card;
an action element requiring the voiding of an action element executed by another player; and
an action element requiring the capping of the bets to a set amount within a round.

4. The poker game of claim 1 comprising:
one of the plurality of action elements selected from a group consisting of:
an action element requiring the showing of a flop, turn or river card to a player executing the action element before the card is shown to the other players;
an action element requiring the discarding of at least one hole card and the random selection of at least one new hole card from the standard playing deck;
an action element requiring the asking and taking of a specific card from a player forcing the player to select another hole card from the deck of standard playing cards or if the player does not have the card selecting another hole card from the deck of standard playing cards;
an action element requiring the retrieving of at least one of the cards from a player that has folded; and
an action element requiring the dealer to deal a board card after the river round to be used by all active players to bet in an additional round.

5. The poker game of claim 1 comprising:
one of the plurality of action elements selected from a group consisting of:
an action element requiring the displaying of all jacks held by all players and the choosing of a jack from those displayed by a player executing the action element;
an action element requiring the displaying of all queens held by all players and the choosing of a queen from those displayed by a player executing the action element; and
an action element requiring the displaying of all kings held by all players and the choosing of a king from those displayed by a player executing the action element.

6. The poker game of claim 1 comprising:
one of the plurality of action elements selected from a group consisting of:
an action element requiring the discarding and re-dealing of a flop card;
an action element requiring the discarding and re-dealing of a turn card; and
an action element requiring the discarding and re-dealing of a river card.

7. The poker game of claim 1 comprising:
one of the plurality of action elements selected from a group consisting of:
an action element requiring the adding or subtracting of a digit to one of the hole cards of a player executing the action;
an action element requiring the changing of the suit of one of the hole cards of a player executing the action element;
an action element requiring the receiving of an additional hole card for a player executing the action element;
an action element requiring the exchanging of two hole cards with a next active player that is sitting two seats away from a player executing the action element; and
an action element requiring the displaying of a hole card to all other players by a player executing the action element.

8. The poker game of claim 1 comprising:
one of the plurality of action elements selected from a group consisting of:
an action element requiring the receiving of an additional hole card from the deck of standard playing cards by all players and the discarding of a hole card by all players; and
an action element requiring the passing of one hole card by all players to a player behind them in the deal.

9. The poker game of claim 1 comprising:
one of the plurality of action elements selected from a group consisting of:
an action element requiring allowing a player that had folded during the game to re-enter the game by executing an action element;
an action element requiring forcing a player other than a player that has executed the action element to remain in the game and bet each round; and
an action element requiring allowing a player that has executed the action element to not bet during the rounds but still remain in the hand.

10. The poker game of claim 1 comprising a plurality of action commands activated through viewer participation.

11. The poker game of claim 10 wherein the viewer participation is through one of at least popular vote or head count.

12. The poker game of claim 1 comprising a plurality of action commands activated through random selection.

13. The poker game of claim 12 comprising a wheel configured to activate one of the plurality of action commands through random selection.

14. The poker game of claim 1 comprising:
one of the plurality of action commands selected from a group consisting of:
an action command requiring an alarm that freezes the deal and requires all players to bet with the cards that they currently have;
an action command requiring a player that has not bet, to bet every bet and cannot fold;
an action command requiring that players have the option to bet, check, or fold on the flop burn card, the flop card, and the turn burn card;
an action command requiring all players to bet every bet and cannot fold; and
an action command requiring the winner of the hand to return half of their winnings to the pot.

15. The poker game of claim 1 comprising:
one of the plurality of action commands selected from a group consisting of:
an action command requiring viewers of the game to play a hand for a player;
an action command requiring the next card from the deck of standard playing cards dealt after a queen be wild;
an action command requiring all players to play with one hole card face up; and
an action command requiring a card to be dealt prior to a burn card and the card dealt is wild.

16. The poker game of claim 1 comprising:
one of the plurality of action commands selected from a group consisting of:
an action command requiring a flop card being dealt face down;
an action command requiring a turn card being dealt face down;
an action command requiring a river card being dealt face down; and
an action command requiring all players placing their set of keys into a bowl and selecting a set of keys that is not their own set of keys and exchanging their hole cards with the owner of the set of keys they selected.

17. The poker game of claim 1, wherein the plurality of action elements comprising a plurality of activation codes indicating when one of the plurality of action elements may be used during play, the plurality of activation codes selected from a group consisting of:
an activation code indicating the action element may be used at any time;
an activation code indicating the action element may be used only when at least three players are active in a round of the variation of the Texas Hold 'Em poker game;
an activation code indicating the action element may be used only during the flop round;
an activation code indicating the action element may be used only during the turn round; and
an activation code indicating the action element may be used only during the river round.

18. The poker game of claim 1, comprising a marker configured to have an active state to indicate a player is participating in a round of the variation of the Texas Hold 'Em poker game; and
a non-active state to indicate a player is not participating in a round of the variation of the Texas Hold 'Em poker game.

19. The poker game of claim 18, comprising:
a controller;
a plurality of sensors configured to determine the state of the marker as active or non-active and send a single to the controller to indicate a player is participating in a round of the variation of the Texas Hold 'Em poker game; and
a counter configured to determine the number of rounds a player participates in.

20. The poker game of claim 19, wherein the marker comprising a red cup; a sensor comprising a coaster; and the red cup in an upright position indicates a player is active; and
a red cup placed in an upside-down position on the player's cards that have been placed on the coaster indicates a player is non-active in order to associate the non-active player's cards with the player providing the opportunity for the player to become active and reenter the game.

21. A method of playing hula poker as a variation of a Texas Hold 'Em poker game, comprising;
dealing two hula cards to each player, each hula card having one of a plurality of action elements;
dealing two hole cards from a standard deck of cards to each player;
having each player have chips to be used for betting;
having each player choose to participate in any round of the game by placing a marker in an active position or choose to not participate in any round of the game by placing the marker in a non-active position;
having any player choose to play a hula card prior to the pre-flop round and if played performing the instructions indicated by the action element;
having each player whose turn it is choose to play a hula card and having the instructions indicated by the action element performed prior to the player choosing to fold, call or raise during the pre-flop round;
dealing the flop cards;
having each player whose turn it is choose to play a hula card and having the instructions indicated by the action element performed prior to the player choosing to fold, call or raise during the post-flop round;
removing any un-played hula cards from the players and dealing two new hula cards;
dealing the turn card;
having each player whose turn it is choose to play a hula card and having the instructions indicated by the action element performed prior to the player choosing to fold, call or raise during the turn round;
dealing the river card;
having each player whose turn it is choose to play a hula card and having the instructions indicated by the action element performed prior to the player choosing to fold, call or raise during the river round;
revealing the hand of each player and giving the player with the best hand the pot;
eliminating players that have no more chips for betting until only two players remain for the showdown rounds;
removing hula cards from the hula deck that cannot be played when there are only two players;
removing any un-played hula cards from the players and dealing two new hula cards;
playing pre-flop, post-flop, turn and river rounds with the option to play a hula card during anyone of these rounds until only one player has chips for betting;
declaring a winner as the only player having chips.
